(19) United States
(12) Patent Application Publication
(10) Pub. No.: US 2015/0187219 A1
(43) Pub. Date: Jul. 2, 2015

(54) SYSTEMS AND METHODS FOR COMPUTER-ASSISTED GRADING OF PRINTED TESTS

(71) Applicant: CLOUD TA LLC, Mercer Island, WA (US)

(72) Inventor: Edward Sheppard, Mercer Island, WA (US)

(21) Appl. No.: 14/582,965

(22) Filed: Dec. 24, 2014

Related U.S. Application Data
(60) Provisional application No. 61/921,391, filed on Dec. 27, 2013.

(51) Int. Cl. G09B 3/06; G06T 3/00

(52) U.S. Cl. CPC G09B 3/06; G06T 3/00

(57) ABSTRACT

A system and method for computer assistance in the grading of printed tests is described herein.

This non-provisional application claims priority to the U.S. Provisional Patent Application No. 61/921,391 filed Dec. 27, 2013, and is incorporated herein in its entirety.

### TECHNICAL FIELD

The present disclosure relates to the grading of tests and, in particular, a method and apparatus which permits a computer to assist in the grading of tests taken by students, particularly students in elementary, junior high, and high schools.

### DESCRIPTION OF THE RELATED ART

Presently, students in high school, normally grades 9-12, and also students in junior high, frequently take tests in order to evaluate their skill level and what they have learned. Tests are usually printed on standard paper, distributed to the students, and the students take the test using pen or pencil. This particular method of administering and taking tests has been used for many years and continues to be used in nearly all high schools in the United States. In addition, it is also used in some college courses, as well as in junior high and some elementary school courses. Unfortunately, the grading of paper tests can be time consuming for the teacher. Another problem is that once the teacher has created the test, it is also time consuming for the teacher to record the test results for each individual student and then distribute those test results to those students and, in many cases, to their parents, as well as update the record of their grades for the class with the test results.

Computerized testing has many benefits but educators nevertheless continue to use printed tests, quizzes, homework, etc. Paper tests are traditional, low cost and easy for students to use. Further, they do not suffer from cross-platform compatibility problems, school information technology outages and other familiar banes of technology.

### BRIEF SUMMARY

According to one embodiment of the disclosure as discussed herein, a computer system is provided which permits tests to be written by the teacher in any standard word processing software, such as Word or the like. The test is thus created as document having a format of .doc or .docx or other word processing format. A selected set of identification codes, fiducial markers and other indicia are added to the test document by the computer program. These other marks are added as part of the .doc or .docx document itself so they are viewed as part of the document by the computer program. The marks might be formatting marks, fiducials, fiducial markers, unique test codes or other identification marks. The tests, as printed, are on standard paper and contain, either in the margins or other locations of the paper, the appropriate identification codes and fiducial markers.

The paper test is then handed out to students who take the test, marking their answers on the paper that contains the test questions. After the students take the tests, the test results are input to the computer by any acceptable technique. The acceptable techniques include scanning in a traditional PDF scanner, taking a photograph with a smartphone, making an electronic copy by any acceptable technique, the electronic copy being in any acceptable format which may include .XPS, .PDF, .TIF, or the like. After the document is input into the computer as a digitized computer file, the data from the tests is sorted in the computer database by individual questions. The grading of the test, either by an individual teacher reviewing the answers or by a machine, is then performed for a single question from each of the tests at the same time. Namely, question no. 1 is graded for all tests at the same time and a score provided for that particular question for each of the tests. The next question is then extracted from each of the tests and it is graded by the teacher for each of the tests and a score provided. The grading of the tests continues until all questions and all tests have been graded. This provides the benefit that the test question, together with the answer, can be presented at the top of a computer screen with the user interface that has on a remainder of the computer screen all the same question which has been selected out of each of the tests. This makes grading very quick and efficient for a teacher or the teacher's assistant who is grading these tests.

A further benefit is that questions can be graded and scores reported on a per-question basis via a quickly generated computer report. Namely, the person scoring the test, whether teacher or assistant, will have presented to them the same question from all exams. They can then quickly mark and grade that single question for all exams. They can then go to the next question and have that single question presented from all exams. Then, the score can be saved and analyzed on a per-question basis for all tests. With current standard paper tests, this is not possible, or if done, is very time consuming to achieve.

In addition, each test can be customized to the individual student's needs and each test can have the questions organized in a different sequence than any other test being given at the same time, to more accurately evaluate a particular student's skill level in that class and also to discourage cheating. Several versions of the test can be created that vary the order of the questions, and when such tests are graded by the teacher, the computer will sort the questions to have all the same questions grouped together even though they may be different question numbers in the tests as administered.

### BRIEF DESCRIPTION OF THE SEVERAL VIEWS OF THE DRAWINGS

FIG. 1 is an overview flow diagram of one implementation of a system for computer-assisted grading of printed tests.

FIG. 2 is a flow diagram for one implementation of a method of computer-assisted grading of printed tests.

FIG. 3A is an example of an individual multiple-choice question, answer choices and an indication of the correct answer.

FIG. 3B is an example of an individual true/false question, answer choices and an indication of the correct answer.

FIG. 3C is an example of a fill in the blank question and indication of the correct answer.

FIG. 3D is an example of a short answer question and an indication of the correct answer.

FIG. 4A is an example of a test key that includes multiple-choice questions and an indication of the correct answer for each question.

FIG. 4B is an example of a test key that includes various question formats and an indication of the correct answer for each question.

FIG. 5A is an example of one implementation of using color coding to identify questions, associated answer choices and correct answers when a test key is scanned.

FIG. 5B is an example of one implementation of using XML enhancements to identify questions, associated answer choices and correct answers when a test key is scanned.

FIG. 6 is an example of a blank multiple-choice test.

FIG. 7 is an example of a blank multiple-choice test with fiducial marks added.

FIG. 8 is an example of an identification number added to a test page.

FIG. 9A is an example of a student identification scheme for a test page.

FIG. 9B is an example of the student identification scheme for a test page that has been filled out.

FIG. 9C is another example of the student identification scheme for a test page.

FIG. 9D is another example of the student identification scheme for a test page that has been filled out.

FIG. 10 is an example of a blank multiple-choice test with fiducial marks and student identification scheme and test identification added.

FIG. 11 is an example of a student-completed test page that includes multiple-choice, fill in the blank and true false questions, fiducial marks, a student identification scheme, and a test identification number.

FIG. 12A is a front view of a smartphone on a stand that is used to capture images of test papers that have been filled out by students.

FIG. 12B is a side view of a smartphone on a stand that is used to capture images of test papers that have been filled out by students.

FIG. 13A is an example representation of a test paper that has been captured by a camera that is not orthogonal to the plane of the test paper and the resulting distortion of the paper in the image.

FIG. 13B is an example representation of the image of the test paper from FIG. 13A that has had transformations applied to the image that result in the image as appearing to be captured by a camera that is orthogonal to the plane of the test paper.

FIG. 14 is an example representation of the image from FIG. 13B that has been transformed into a highly and uniformly contrasted image in preparation for grading.

FIG. 15A shows one implementation of a user interface for grading questions of multiple tests by separating out question responses as either correct or incorrect.

FIG. 15B shows one implementation of a user interface for automatically grading questions of multiple tests.

FIG. 15C shows another implementation of a user interface for grading questions of multiple tests by separating out question responses as either correct or incorrect.

FIG. 15D shows an implementation of the user interface for automatically grading questions of multiple tests.

FIG. 16A shows an example of a test identification distorted due to blur and smear caused by improper camera focus and camera motion.

FIG. 16B shows an example of an undistorted test identification that can be used to improve recognition.

FIG. 17A shows an example of a camera angle looking at an XY plane along a non-orthogonal axis to the XY plane.

FIG. 17B shows a coordinate system UV on an orthogonal projection plane from the camera angle in FIG. 17A as plane XY is rotated.

FIG. 17C shows two different points in the XY plane and UV plane that are collinear with the camera.

FIG. 17D shows the rotation of the two different points in the XY plane.

FIG. 18 is a schematic diagram of one implementation of a computing environment for systems and methods of providing computer-assisted grading of printed tests.

FIG. 19 is an example of a smartphone camera and stand used to capture digital images of completed test papers.

FIG. 20 is a plan drawing of the example in FIG. 19.

### DETAILED DESCRIPTION

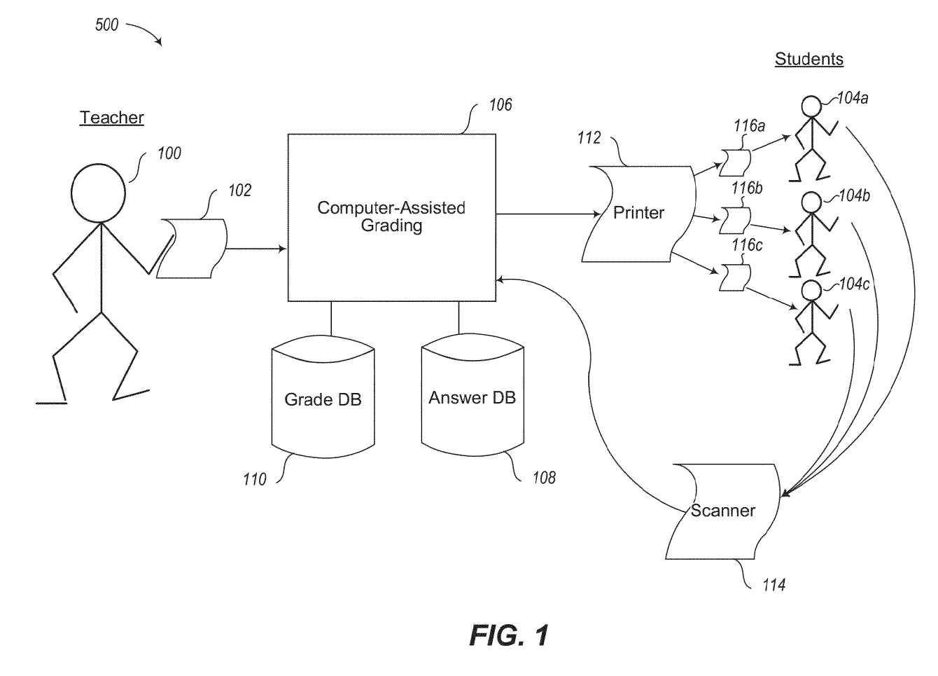

FIG. 1 shows diagram 500 that is one implementation of a system to implement the computer-assisted grading of printed tests. A teacher 100 develops a test key 102 to give to students 104a-104c, for example to evaluate their knowledge of one or more subjects in response to being taught the subjects. The test key 102 may consist of one or more test questions that also include a list of possible answers for the student to select, empty spaces for the student to write in short answers, empty spaces for the student to write essay answers, and areas to indicate true false selections. In some implementations, the test key 102 is written on one or more pieces of paper, whereas in other implementations the test key 102 may be in an electronic representation such as a Microsoft Word™ document file.

In other implementations, teachers may have only a hard copy of their tests. In this case, the hard copy can be scanned and loaded into the system. The system then presents the pages to the teacher who selects the questions to indicate their page locations. The system would still add fiducial marks and codes to the scanned hard copies just as it would a text document.

The test key 102 is entered into a computer-assisted grading system 106. This may be accomplished by sending an electronic representation of the test key 102 to the computer-assisted grading system 106 by scanning the test key 102 into a digital form, or by electronically transmitting an existing electronic representation of the test key 102 to the computer-assisted grading system 106.

In one or more implementations, the computer-assisted grading system 106 will analyze the test key 102 to determine the questions, the possible answer choices and the correct answers. At least part of this analysis includes identifying and storing test questions and their associated correct answers in an answer database 108. The answers stored in the answer database 108 are subsequently used to evaluate and grade the completed tests that are received by a scanner 114.

Once the analysis is complete, the computer-assisted grading system 106 assembles images of the test, including test questions and answer choices or locations to fill in a written answer, and sends the images to a printer 112. The printed tests 116a-116c are then given to individual students 104a-104c for the student to fill out. In some implementations, the computer-assisted grading system 106 may also add to each test page unique identification numbers, student identifiers, areas for students to fill in their name, or other student identification, fiducial marks, or other printed indicators to assist in the recognition or scoring of the printed test. These are discussed below in more detail.

Once the students 104a-104c have completed the test and have filled in the answers, the test pages are collected and placed in a digital format. This can be accomplished by taking a photograph with a smart phone, a digital camera, digitally scanning them through a scanner 114 or other technique. The digital format can be a bit map of the paper test or it can be intelligent copy, namely one that has the characters and data in digital format or stored as a digital document, not as just a bit map. The results are returned to the computer-assisted grading system 106 where the individual test questions and answers are identified and may be graded, either by a computer-based system or by human involvement, such as by teacher 100.

The tests may also vary in the questions themselves and their difficulty. This can potentially be done down to the student level with each student receiving a test particularized to that student's needs.

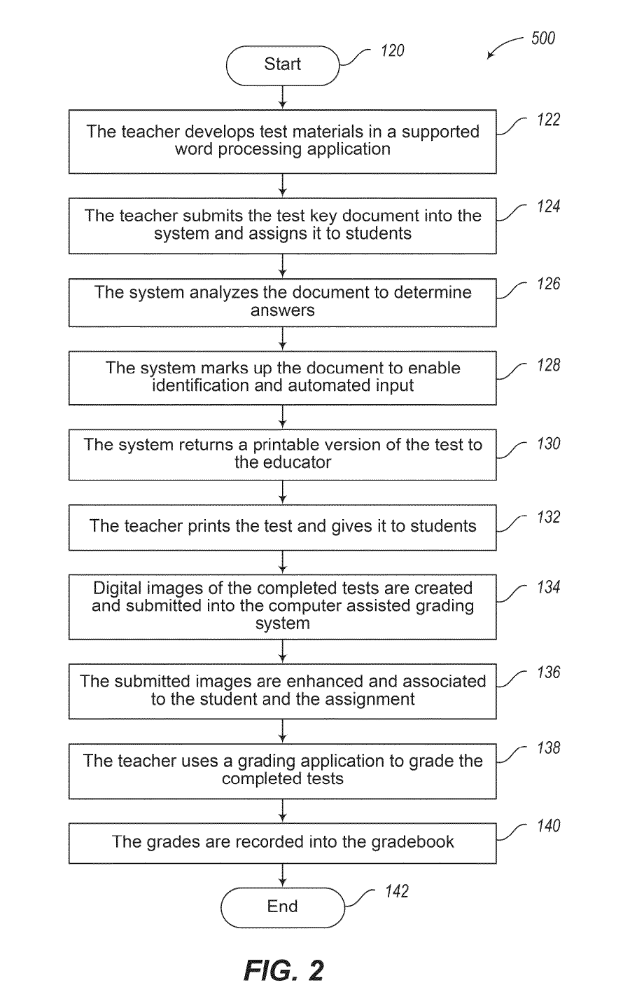

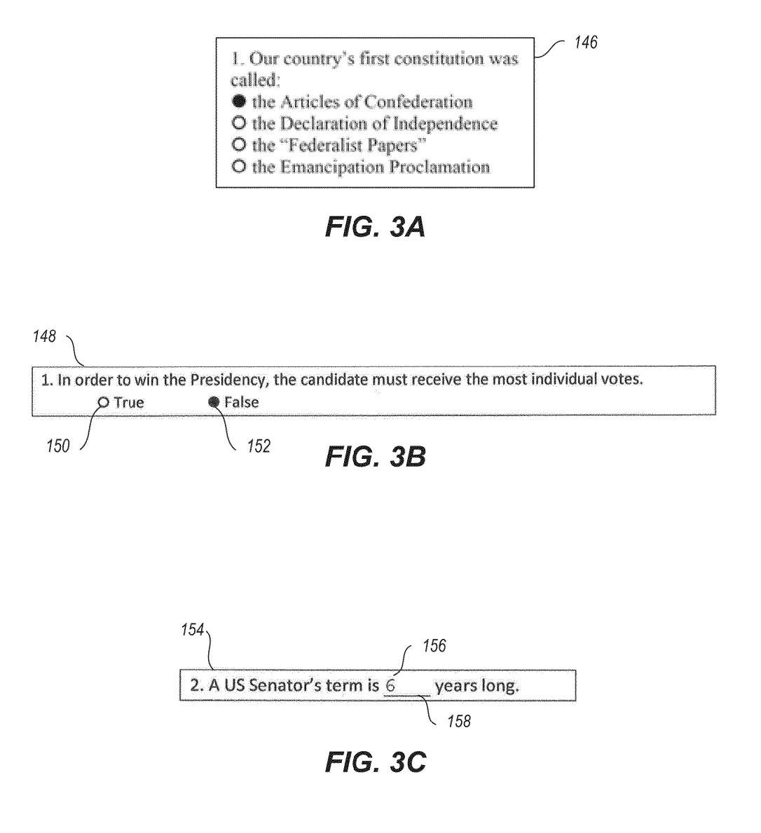

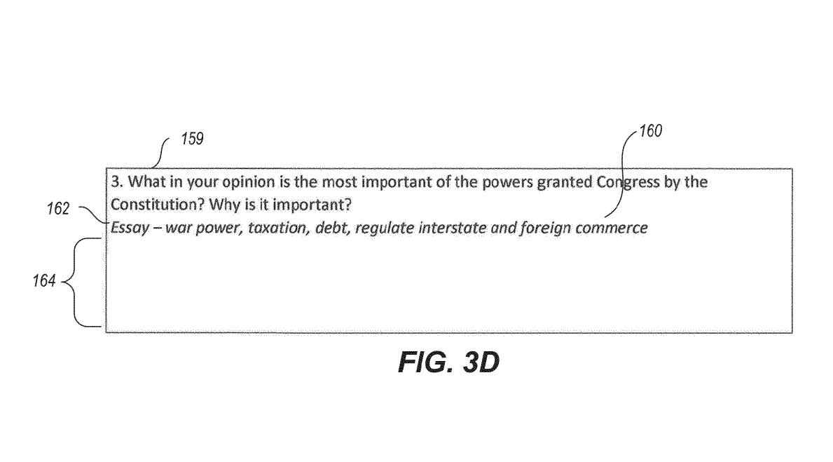

FIG. 2 shows a flow diagram 550 that describes one implementation of a method for implementing computer-assisted grading. The method starts at step 120. At step 122, the teacher develops test materials in a supported word processing application. The teacher 100 may be an educator or some instructional professional. In one or more implementations, a teacher may use Microsoft Word™ to develop test key 102 documents as ordinary Word™ documents. Questions and their answers are encoded in the test key 102 document by simple patterns. Examples of these patterns are given in FIG. 3.

At step 124, the teacher submits the test key 102 document into the system and assigns it to students. In one or more implementations, the document may be assigned to specific students, to a group the students, or be generally available to any student who receives a copy of the test to take.

At step 126, the system analyzes the submitted test key document 102 to determine answers. Once the answers are determined, these answers and their associated questions are stored in the answer database 108.

At step 128, the system marks up the test document that eventually becomes one or more printed tests 116a-116c. These markups may include fiducial marks, test identifiers, student identifiers, identification of areas for students to fill in the name or other student identification, or indicators to be printed on the test.

At step 130, the system returns a printable version of the test to the teacher. At this step, the teacher is able to review the test.

In one embodiment, steps 128 and 130 are not used. In particular, in one embodiment, the teacher creates the test and also the answers to the test in a single document. The system then stores the test as single document, with the questions and the correct answers. Then, when step 132 is carried out, the teacher prints a version of the test with the answers removed. Namely, the answers spots will be blank in the version the teacher prints for the students, but they are present in the same document as stored in the computer. The teacher has the option to print out and view a version with the answers removed or the answers present. This can be accomplished with a hidden text feature.

At step 132, the teacher prints out the test and gives it to the students. In one or more implementations, a single test may be printed multiple times and given to several students or the computer-assisted grading system 106 may print multiple printed tests 116a-116c that are tailored for each student. In other implementations, this step may reorganize the placement of the questions on the test, for example reordering the test questions, to reduce the likelihood of cheating by students.

At step 134, digital images of the completed test are created and submitted to be computer-assisted grading system. At this step, the individual tests are scanned, for example by a conventional scanner or by digital image photography using a smartphone to create digital images of each test page.

At step 136, the submitted images are enhanced and associated to the student and the assignment. At this step, the student and the assignment may be identified by marks on the printed tests documents 116a-116c or by student names or other student identification written on the documents prior to scanning.

At step 138, the teacher uses a grading application to grade the completed tests. As discussed further below, grading may involve human intervention or may be done without human intervention in an automated fashion.

At step 140, the grades are recorded. In one or more implementations, the grades are entered into a grade database 110 that tracks multiple students and multiple graded events.

At step 142, the sequence for this set of steps has been completed.

One benefit that is obtained by this method is the ability to customize tests for each student. As explained in more detail herein, the method permits the same question to be located at different places on a each students paper. A particular question can be question 1 for some students while the very same question will be question 7 for others and then question 16 for others. This is a deterrent to cheating and requires that each student work only on their own test and not rely on answers that other students gave to the same numbered question since it will be different question on the same test. A further benefit is that metadata can be used to select questions and analyze responses. A specific example is that the questions can be annotated with associated standards that might be put out from a school district or a government agency. Then a teacher could, for example, use test questions that meet or show learning of some particular set of standard elements which the system could automatically generate. After the test is taken, the teacher can see how any particular students are doing on those standards. A report can be provided on a per-student basis regarding mastery of a particular set of standards. The results can be fed back into the system to particularize tests for students based on their mastery of the standards.

For purposes of specificity, the discussion above employs Microsoft Word as the test preparation tool, but nearly any modern word processor or page layout program would do. Most such programs are programmable. Even programs that are not generally have a published file format that can be parsed for question and answer patterns. For example, the system could utilize Open Office XML directly instead of working through the Word API, or reload color encoded DOCX and direct Word to print to an XML Paper Specification file. Any such program having a document format that can be understood and that can be commanded to print can be used.

Furthermore, XML Paper Specification file is only one print format that can be used although it is certainly the easiest to utilize. A popular but complex print format is PDF and many word processors can print in this format. For example, this is the only way to print from the Word Office Web App. The system could download the DOCX of the test document, inject color, upload back to the Word Office Web App, command it to print to PDF, and then parse the PDF to determine page locations.

Client test creation programs also need not even support printing to a file. Rather, a print driver can be employed. For example, the Microsoft XML Paper Specification file print driver could be specialized so that programs which print to it get their output saved into an XML Paper Specification file.

FIG. 3A-3D show one or more implementations of questions, answer choices and correct answers that may be found on a test key 102, which may also be referred to as an answer key. During grading, the answers found on test key 102 will be shown side-by-side with students' completed tests for comparison and scoring.

In one or more implementations, teachers use Microsoft Word™ to develop tests as ordinary Word™ documents. To assist the teacher in developing tests, the system may include one or more Word Add-ins with functions to re-number questions, turn text into a short answer, insert multiple choice options, and so on. An especially important function is test validation that would, for example, check that questions are numbered consecutively, that each question has some answer and every answer belongs to a question. Yet another Add-in function would allow a test preview so the teacher can see how the final test will appear to students.

When creating a test key 102, questions and their answers are included in the document by simple patterns. There are a number of different patterns that may be used to identify these areas on the test key 102.

FIG. 3A shows an example of a test question that is introduced and identified by a paragraph that starts with a number, then a period, then white space. In this example, the paragraph starting out “1. Our country . . . ” 146 would indicate the beginning of question number one.

FIG. 3B shows an example of a multiple-choice answer 148 that may be indicated by the Wingdings™ glyphs 150, 152 used by the test taker to indicate a false or true choice response by filling in the proper glyph 152.

FIG. 3C shows an example of a short text answer 154 that is indicated by a mono-spaced font 156, like Courier New. In this example, underscores 158 have been added to provide more space for the student's responses.

FIG. 3D shows an example of one implementation of an essay question 159 that is indicated by consecutive italicized paragraphs 160 starting with the leading word “Essay” 162. Note, extra blank paragraphs 164 have been added in this example to give students more room to write their answer.

Many other kinds of test questions can be thought of and employed, so long as they have a detectable pattern. For example, it is common to have a set of questions whose answers are chosen from a menu. The menu answers can be labeled by number or letter and these labels are put into the answer spaces of the questions.

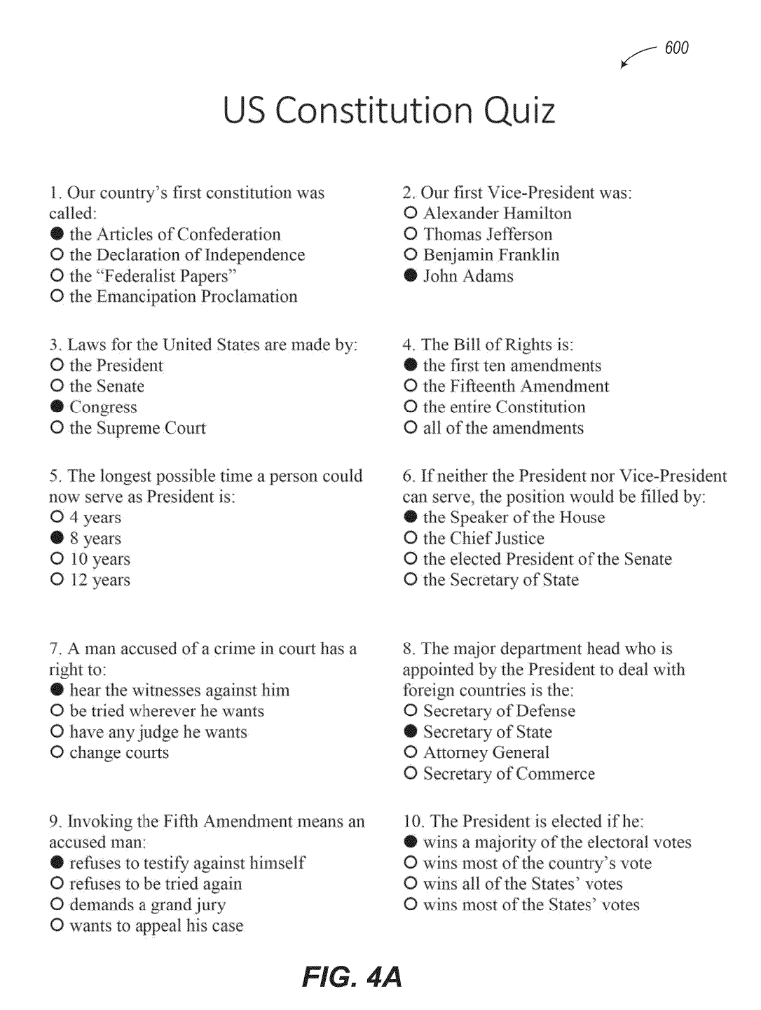

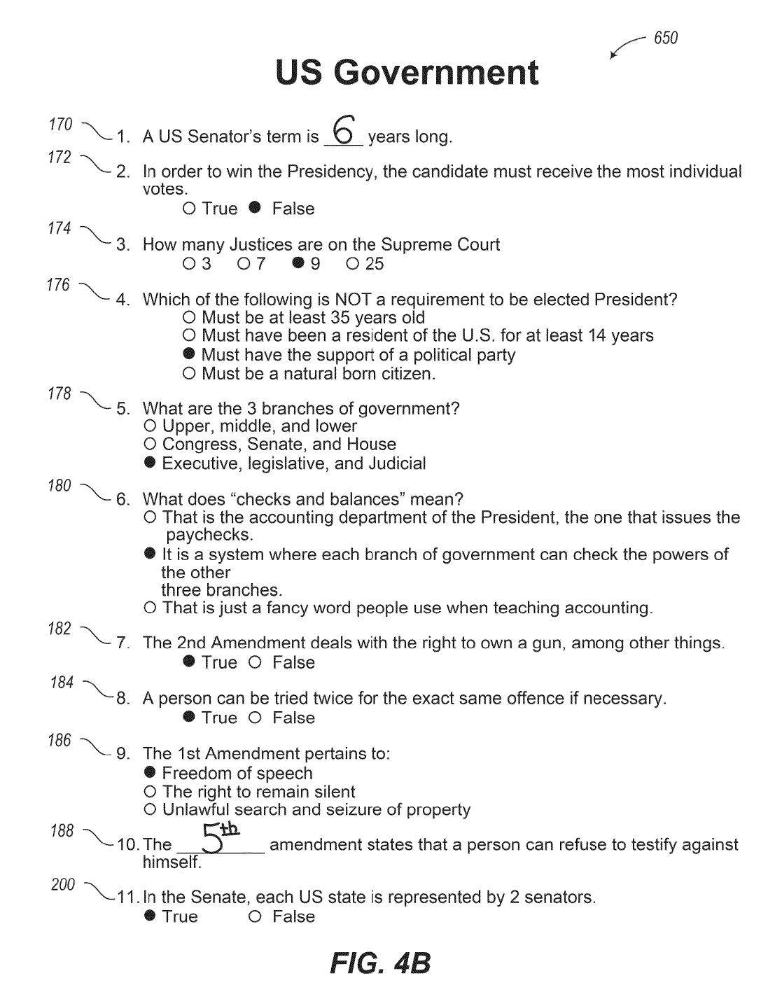

FIGS. 4A and 4B show examples of a test key 102 that has been created and is prepared to be submitted to the computer-assisted grading system 106 to be analyzed and transformed into a test document to be used for later grading. In one implementation, the system (1) discovers the printed location of the questions and answers on the test key 102, (2) removes the answers from the test key 102, (3) places markups on the final test document so that during scanning perfect digital images can be aligned with the test key 102, and (4) adds codes and other markup so that images can be automatically associated with a particular assignment and a student.

FIG. 4A shows diagram 600 which is an example printout of a test key of a multiple-choice test on the U.S. Constitution having 10 questions. Each question has four possible answers, and for each question the correct answer is marked with a filled in circle.

FIG. 4B shows diagram 650 which is an example print out of a test key with multiple question types on the U.S. Government having 11 questions. In this example, there are two short answer questions 170, 188; four true/false questions 172, 182, 184, 200; and five multiple-choice questions 174, 176, 178, 180, 186.

To perform processing of a test key such as those shown in FIGS. 4A and 4B, the system works with the test in a print file format. That is, it makes some preliminary change to the document, “prints” the document to a file then reads and processes the print file. In one or more implementations, the XML Paper Specification file print format is used as it is easily utilized, well documented and has very good support in Word.

A key task is using the print file to discover where the questions and answers discovered by searching the Word document for question-answer patterns will print on the page. The raw XML of an XML Paper Specification file document does not easily enable associating the printed elements back to the source Word content. The only hard-and-fast requirement for XML Paper Specification files is that the printed page look as it is expected to look. Word is free, for example, to generate a single subsetted and combined font with only the glyphs needed to print, assign them arbitrary indices, even omit the (optional) Unicode String attributes and print the characters in any order. Searches based on the text content of the XML Paper Specification file therefore cannot be considered reliable.

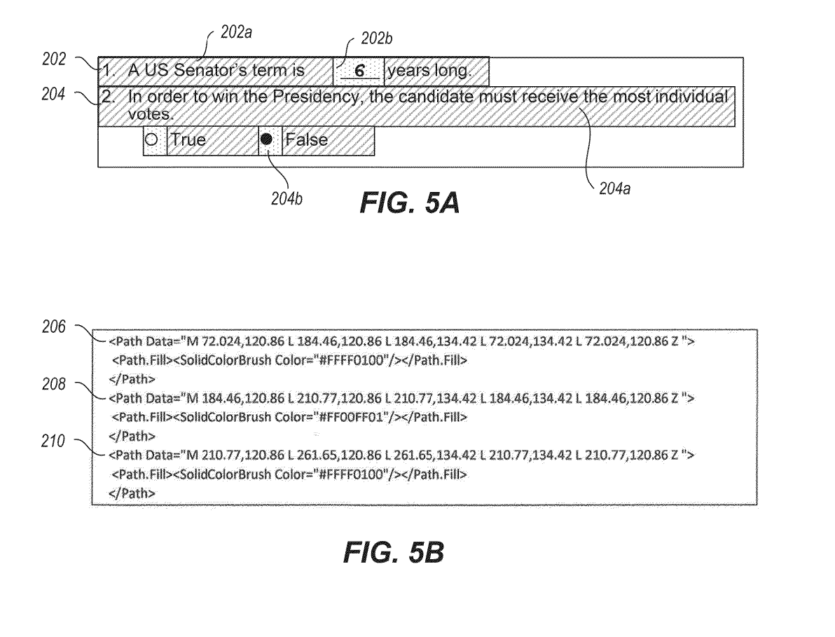

FIG. 5A shows one implementation of a reliable search that can be obtained by injecting color overlays or shading into the document source content that enable correlation of XML Paper Specification file page positions with the Word document content. When it prints, Word must pass these colors through to the XML Paper Specification file but the colors do not affect the page position of any content. FIG. 5A shows how shading or a color overlay could be used for encoding the locations of text content. A light color, such as yellow, blue or other semi-transparent color or other shading can be overlaid on top of the question. For example, for question 1 202 it might set the shading of all paragraphs of question 1 202a to the color #FFFF0100 and the shading of question 1's answer 202b to #FF00FF01. For question 2 204, the shading of the paragraphs of question 2 204a to #FF0000FF, and the shading of question 2's answer 204b to a different color and so on. There are 16,777,216 colors available, far more than needed for any reasonable document. Of course care must be taken to not use colors the teacher has used himself in the answer key document.

FIG. 5B shows the various shared regions in the XML Paper Specification file as closed <Path> elements with a Fill attribute set to a color. FIG. 5B shows how the color encoding for question 1 (FIG. 5A 202) might be represented.

There are three <Path> elements 206, 208, 210 because the answer is within the question's paragraph and Word has chosen not to overlap the <Path> elements. The representation is not unique. Word could, for example, have chosen to overlap them but place the answer's <Path> in front of the question since the latter color is opaque. But no matter how they are represented, the collection of <Path> elements with the same Fill color can all be found and the smallest bounding rectangle bounds the question. The bounding rectangles of all the questions and answers are saved as their page locations. Once the question and answer print locations have been found, the color information is no longer needed and is discarded.

Use of color encoding can be more extensive than simply shading question and answer backgrounds. Because so many colors are available, every single character in the document could potentially be so encoded and the print location of every character would then be known. This would enable very fine grained adjustments in the student submission images.

One use of character-by-character location information is to correct for the fact that paper never lies perfectly flat and even a slight curl adds a perturbation. This perturbation can be modeled as a local displacement field. By comparing every character's ideal print position to where it actually lies in the image, the displacement field can be approximately inferred and then inverted. This improves alignment with the answer key even more, thus giving an even better grading experience.

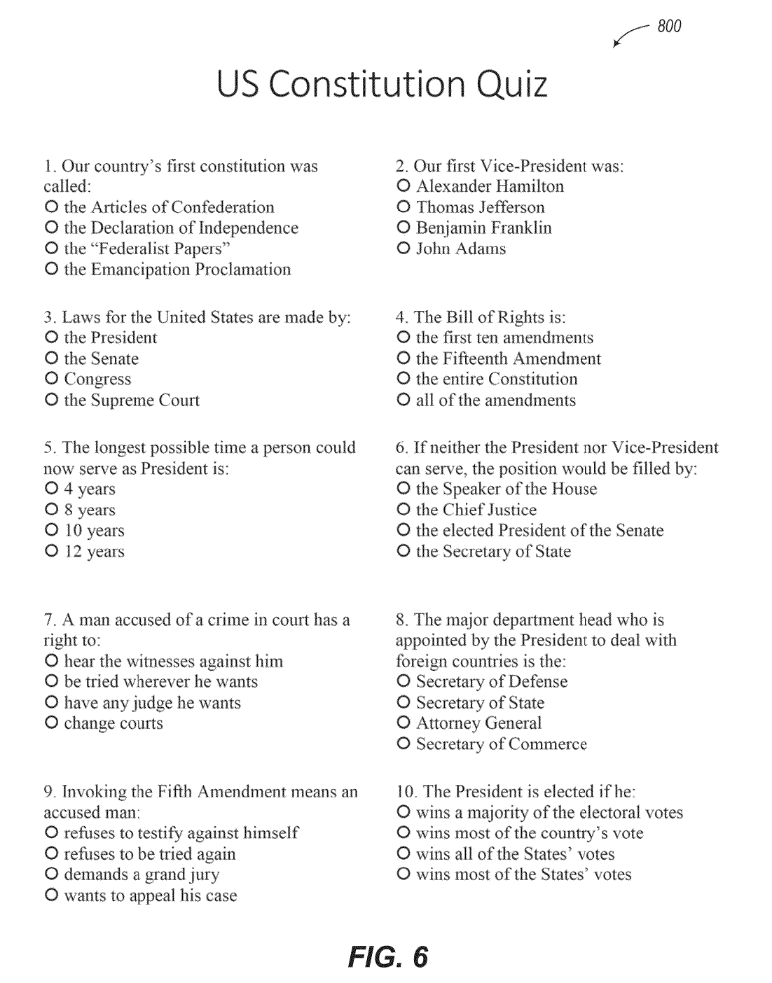

FIG. 6 shows diagram 800 of the example U.S. Constitution Quiz of FIG. 4A with the answers removed. In one or more implementations, the answers are removed from the key in a way that does not affect print layout. In multiple choice, occurrences of are replaced by ◯ (these glyphs are the same size). In short answers, underscore replaces all other characters (the font is mono-space so this will take up the same space). Text in essay answers is made transparent.

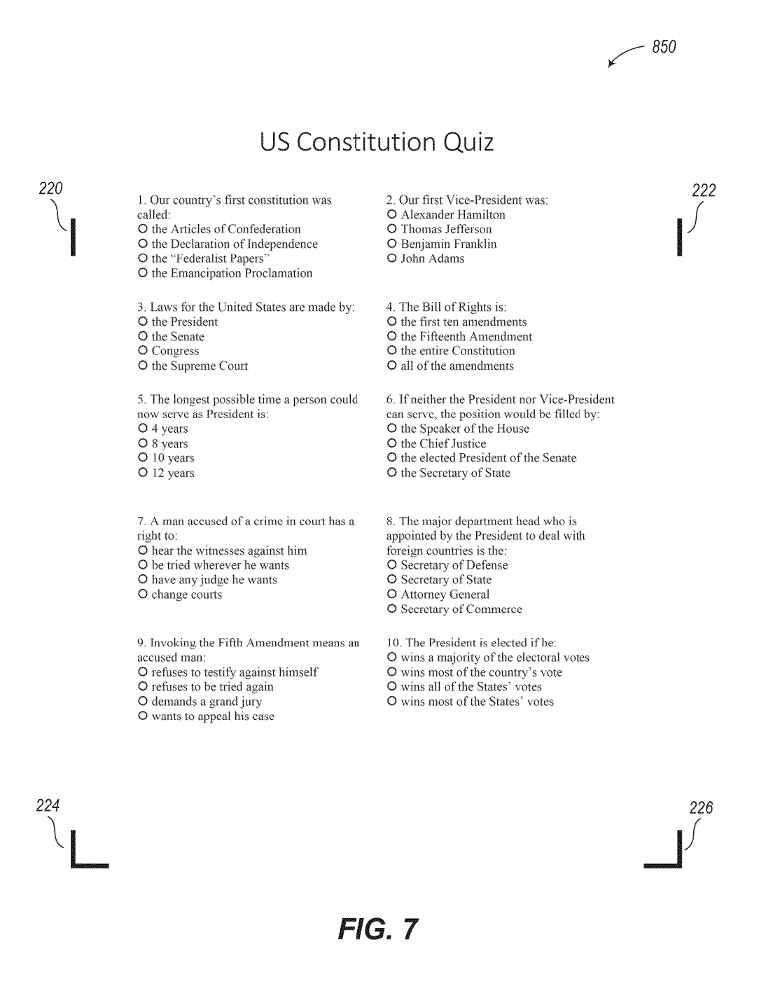

FIG. 7 shows diagram 850 of the example U.S. Constitution Quiz of FIG. 6, with one implementation of fiducial marks added. During later grading, digital images of students' completed tests will be submitted. The images will need to be aligned with answer key for grading. However, all digital images are imperfect representations of the original paper to some degree. For example, the images may have been captured with a camera and need to be significantly scaled, rotated and projected. Even very good images captured by a scanner will suffer some skew and it is very easy to scan upside-down. To enable aligning images with the answer key, the system adds fiducial marks to the documents. As shown in FIG. 7, a mark is put in the corners 224, 226 and an “orientation bar” is placed on a side 220, 222.

The system will later search the digital images for these marks and, by comparing their actual locations to ideal print locations, infer a camera transform which is then inverted to get a better aligned image of the test.

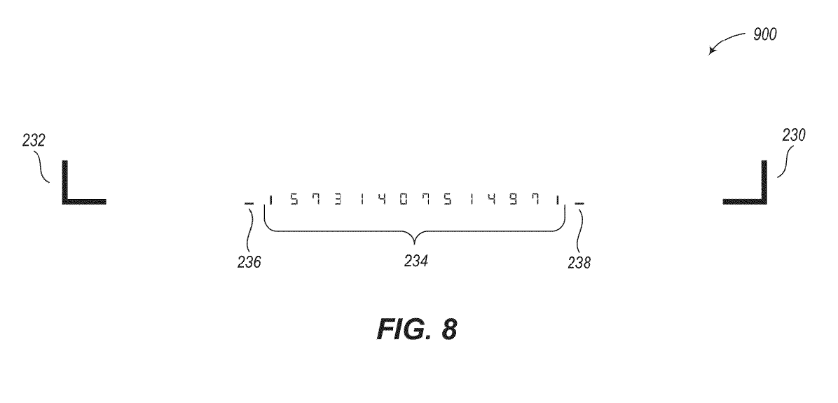

FIG. 8 shows diagram 900 of one implementation of identifying a page of a printed test. Teachers can have different classes taking different tests at the same time. The submitted images from the different classes and tests must be associated with the right assignment for grading. This can be done manually by the teacher, going through the images one at a time, but it is much better if the system can do it automatically. To enable that, the system assigns a code number 234 for every different test page and adds it at the bottom of the page. The system identifies and reads the code, in some implementations by using fiducial markers 230, 232 or alignment bars 236, 238 from the images to determine the proper corresponding test pages.

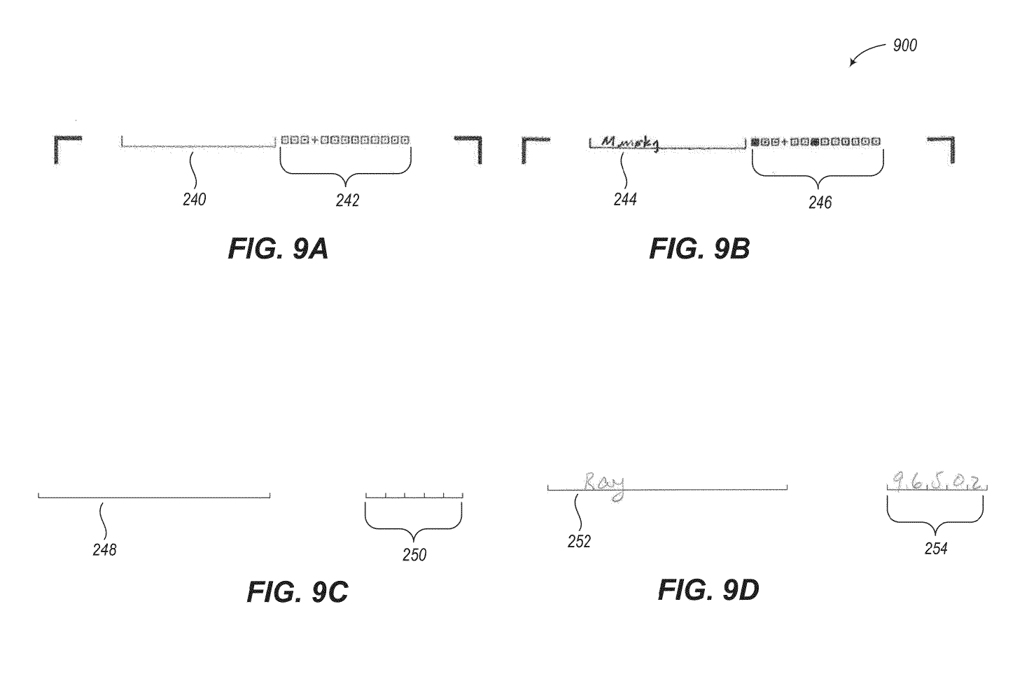

FIG. 9A-9D shows example implementations of associating a test with the right student. Although this could be done manually by the teacher, it is better if done automatically.

FIG. 9A shows an example of providing a section at the top of a page where a student may be identified by name 240 and a student number 242. For example, students in a class may be assigned consecutive identification numbers, 1, 2, 3, etc.

FIG. 9B shows an example of a student who has filled in a name 244 and filled in boxes to indicate the tens and ones digits of student's number 246. The system associates an image to a student based on which boxes are filled. The system also adds space for student names as a backup in case the code recognition fails.

FIG. 9C shows another example of providing a place for a student identification name 248 and a number 250. Entering student codes using a tens-and-ones scheme will usually be suboptimal. For example, if several teachers in a school are using the system, either they must all agree on every student's code (hard when the teachers do not all have the same students) or students will have to remember a different code for each class (doable but error prone). Usually, however, a school will already have multi-digit IDs for students. It is better to let students use those by writing their codes by hand in an allotted space. Handwriting recognition for isolated digits and letters can be quite high. Recognition can be improved over time by training as the students submit additional tests.

FIG. 9D show an example of a student who has filled in a name 252 and a student number 254.

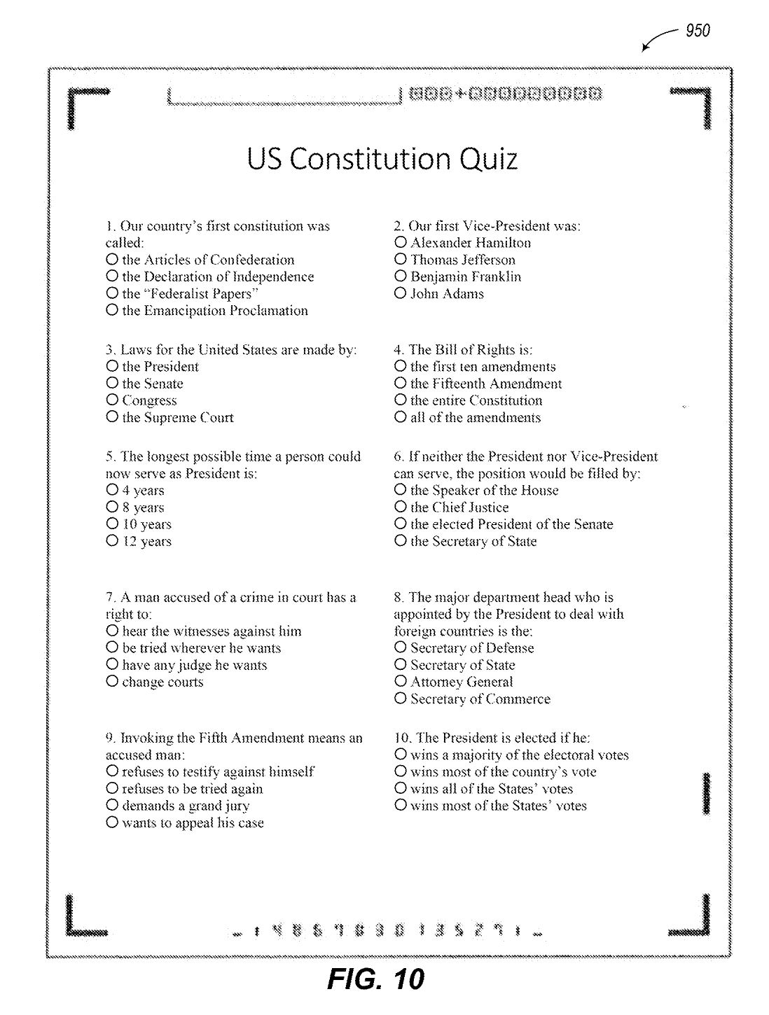

FIG. 10 shows diagram 950 as an example of a printed test page 116a that is ready to be distributed to a student for completion. FIG. 10 shows how the student code section at the top of the page would look and how a student would fill it in.

Students return their completed tests to the teacher who creates digital images of them and submits the images to the system to be prepared for grading. One way of producing high quality digital images is a scanner (not shown). Many scanners have an automatic document feed so creating the images is easy. After they are all scanned, the images are collected from the scanner and uploaded to the system for grading.

However, teachers may not have access to a scanner or prefer not to use one for various reasons. Mechanical feeds often jam, and jams can often rip the paper and destroy the student's work. Scanners can also be difficult to configure. In addition, the scanner might be shared and often unavailable, for example an all-in-one unit that is frequently in use for printing.

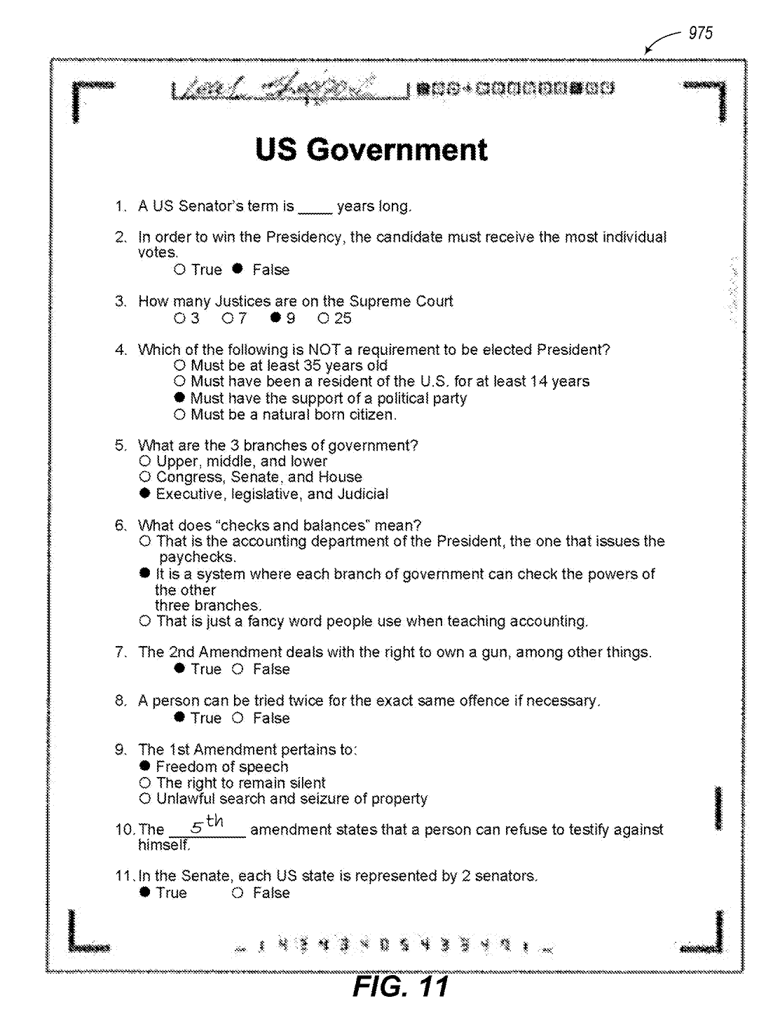

FIG. 11 shows diagram 975 of an example of a test that has been completed by a student.

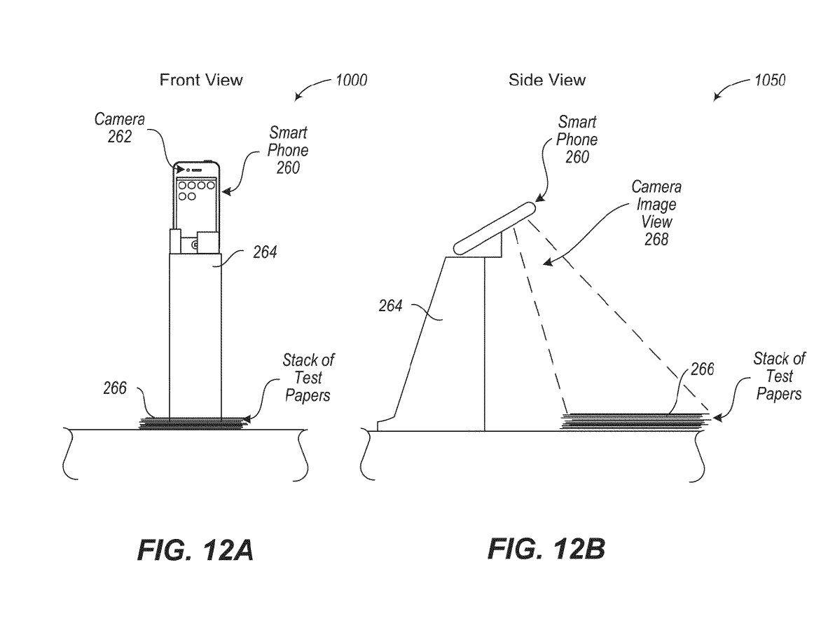

FIGS. 12A and 12B show diagrams 1000 and 1050 that give an example of a front-view and a side view of a smartphone 260 and a stand 264 which may be used for capturing completed student tests.

Most teachers have a readily available alternative, the high density camera in their smartphone. For example, a Motorola Droid™ 3 smartphone (not shown) has a camera image of 1840×3264 pixels. If a letter sized page were perfectly aligned to fit within the camera field, the horizontal resolution would be 1840/8.5=˜216 dpi. Of course, in practice the page will never exactly fit but resolutions of 170 dpi are easily obtained, very adequate for grading on a ˜100 dpi display device.

The smartphone 260 will be placed at the top of stand 264, and placed at an angle such that the camera 262 within smartphone 260 is able to capture a digital image of the test papers 266 that are along the camera image view angle 268.

In one or more implementations, the teacher could use the device-provided (smartphone 260) camera application to take images of the pages of the students' tests, and then copy the image files to a computer and upload to the computer-assisted grading system 106 for grading. In another implementation, to save time, the system provides a smartphone camera application for supported device platforms to manage taking the pictures and automatically submit them to the computer-assisted grading system 106. In this example implementation, because the pictures are uploaded as they are being taken, no special upload step is required. If the network is very fast, the completed test images will be available for grading almost as soon as they are taken.

When using a camera 262 it is highly desirable to use a stand 264 or platform. The added stability will dramatically improve original image quality compared to holding the camera 262 in a hand whose tremors, perhaps even from a heartbeat, can affect the image. Using a stand 264 also keeps both hands free to position the paper for quicker repositioning. And the camera focus will stay the same throughout the process, saving even more time. Using a stand 264, with practice, rates of five seconds per page are easily obtained. The stand 264 need only hold the device at one angle and a fixed distance relative to the paper and, therefore, is very simple and of low cost.

The system speeds up the grading phase so dramatically, the time to get the students' submissions into the system becomes a trivial factor. This can be reduced by improvements in the smartphone camera app. For example, rather than require the teacher to position each page then touch a capture button, the app could continuously monitor the camera image looking for sufficient details to know that a new page has been placed and then upload the image giving sound feedback to the teacher that the page is captured. Upload speeds of a few seconds per page become possible.

The smartphone upload app can become smarter in other ways. For example, it can detect the fiducial marks itself and thereby determine exactly which part of the image is the test page and upload only that portion, rather than the whole camera image. This would substantially reduce upload bandwidth needs.

In addition, the fiducial marks may be done away with altogether if the test page is imaged against a dark enough background that the page corners can be detected reliably.

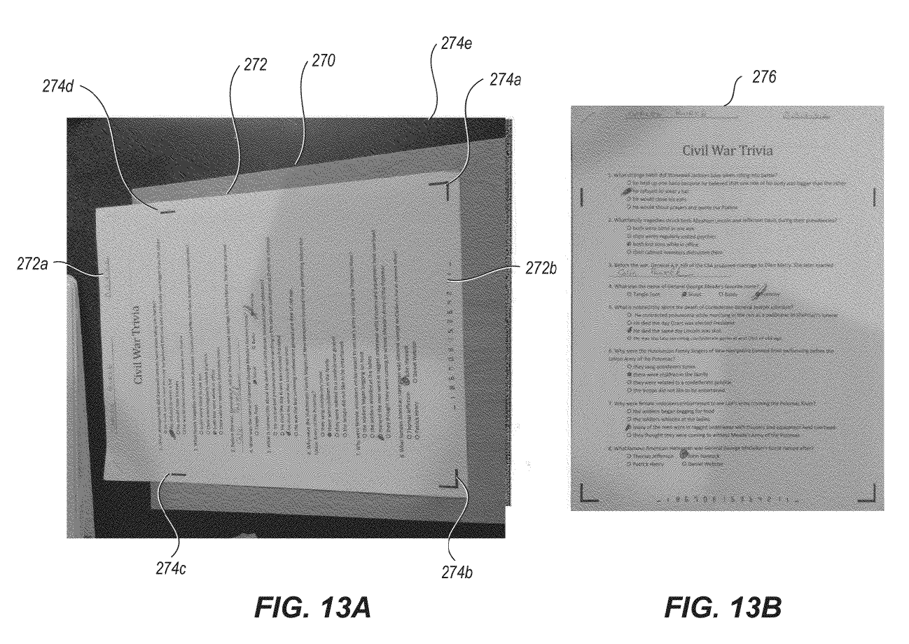

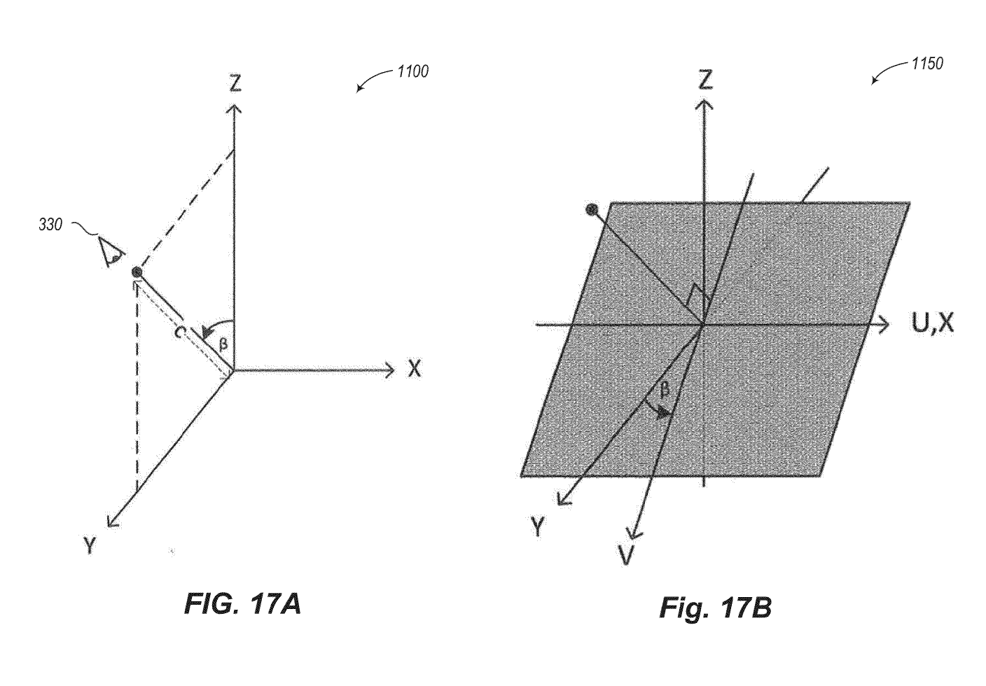

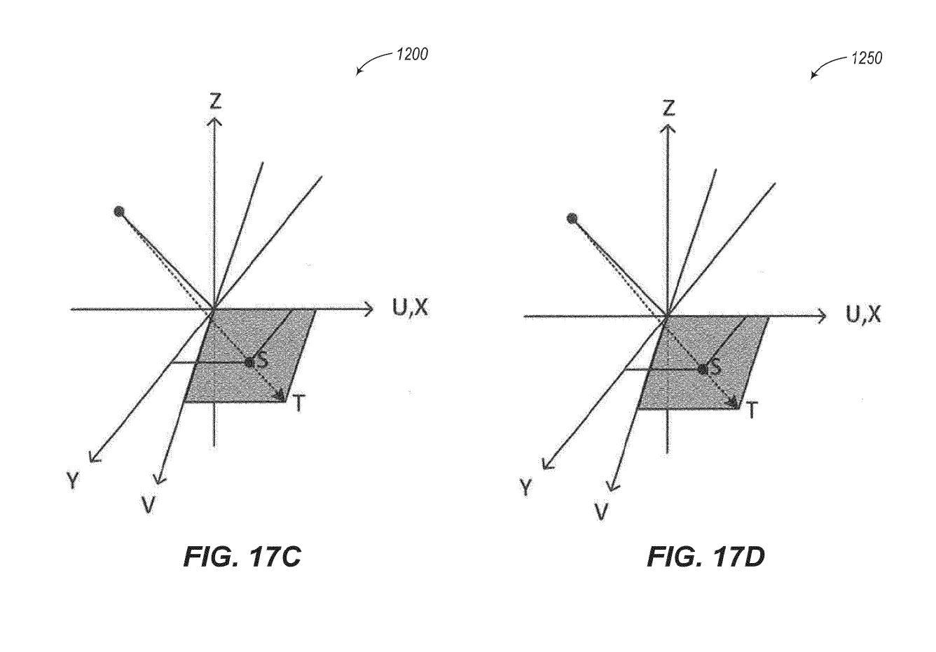

FIG. 13A shows an example digital image 270 of a completed test paper 272 that was captured by a camera 262. In this example, the digital image 270 is distorted because the camera 262 was positioned in a non-orthogonal angle to the completed test paper 266. The top of the image of the test paper 272a appears narrower than the bottom of the image of the test paper 272b. In one or more implementations, this distortion is corrected for by using the fiducial marks 274a-274e printed on the completed test paper 272 prior to scanning. These marks are used to align the image 270 so that it may be compared with the answer key. Implementations of this image alignment process are discussed in detail in FIGS. 17A-17D below.

FIG. 13B shows an example of an aligned digital image 276 that was based on the captured digital image 270 using fiducial marks 274a-274e.

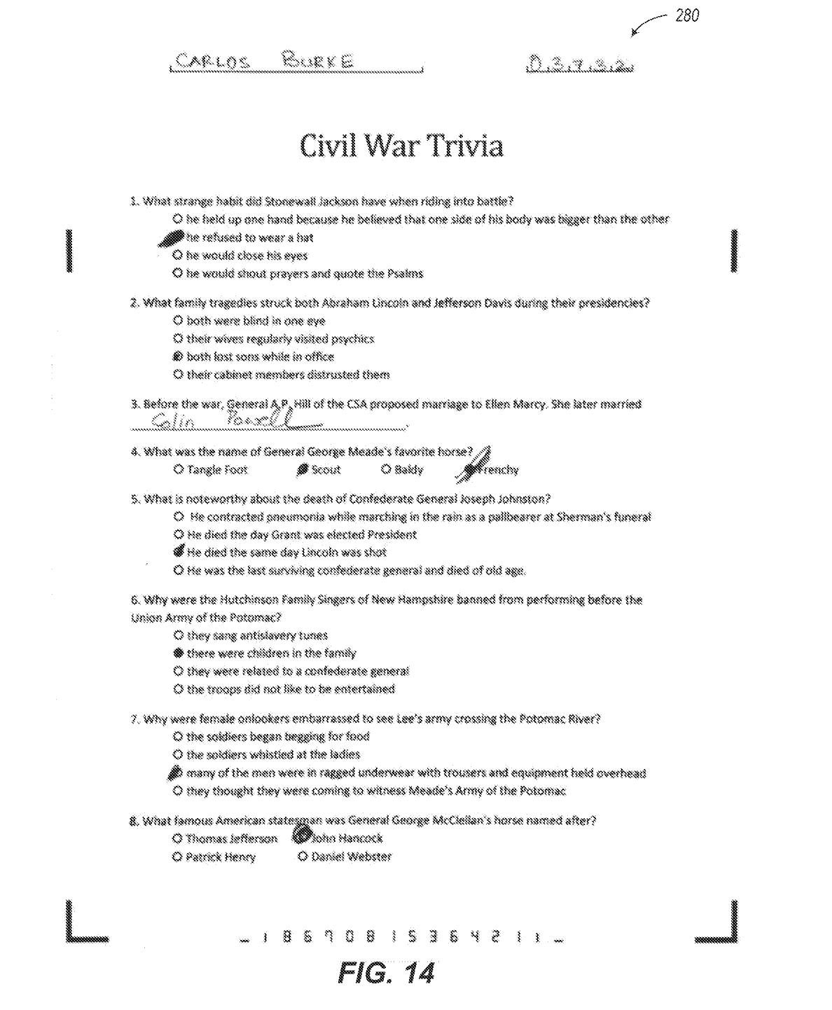

FIG. 14 shows an example of an aligned image of a test paper 280 that has been further digitally processed into a highly and uniformly contrasted image.

Images created with a scanner 114 will have high contrast with black text on a white background, but camera 262 images will generally have a much compressed range which, furthermore, varies place to place in the captured image. This is due to inhomogeneous illumination resulting from curling of the paper, different directions of ambient lighting and, as the picture is usually taken at an angle, different distances from the camera to the different parts of the page. Even more noticeable, intensities will vary from image to image. For example, if the sun came out halfway through the image capture process, a light was turned off, the pages just were not placed identically each time or, as in FIG. 14, the page was partly in shadow.

Variations in intensity and contrast are distracting and will negatively affect the grading process. It is therefore desirable to adjust the images so they have high contrast and the same range within and between images. There are many applicable image processing techniques. For example, the background can be identified and intensities added based on local background levels. After background intensities are equalized, the foreground can be deepened to black. Together these two transformations can give highly and uniformly contrasted images.

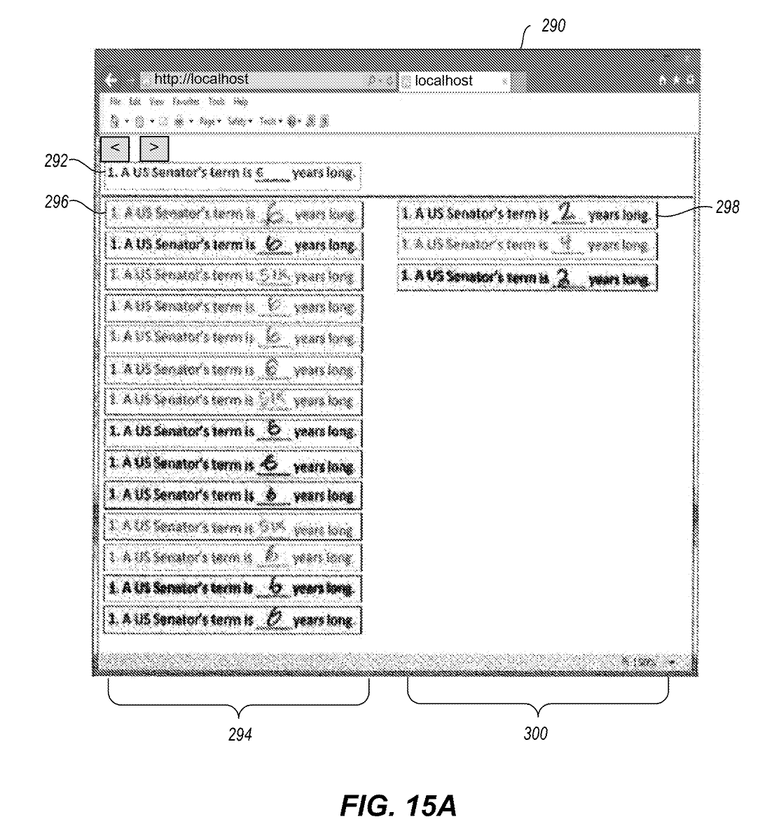

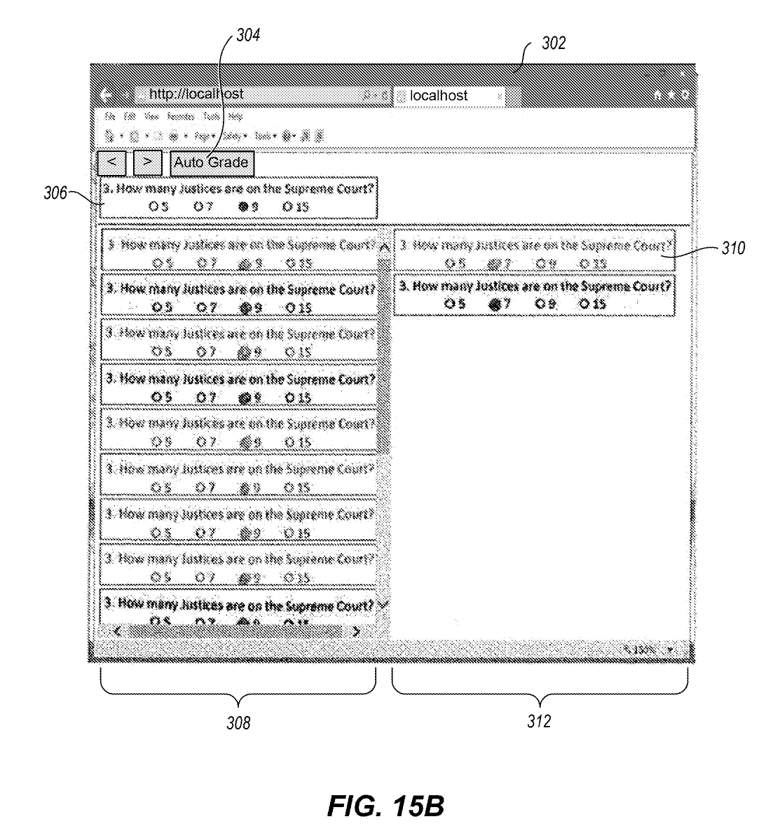

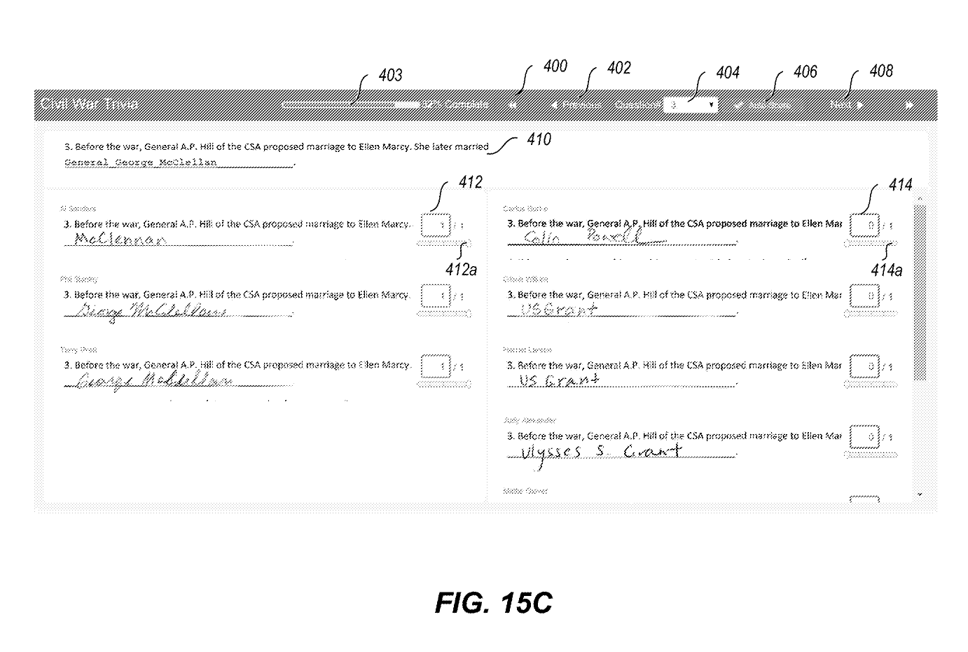

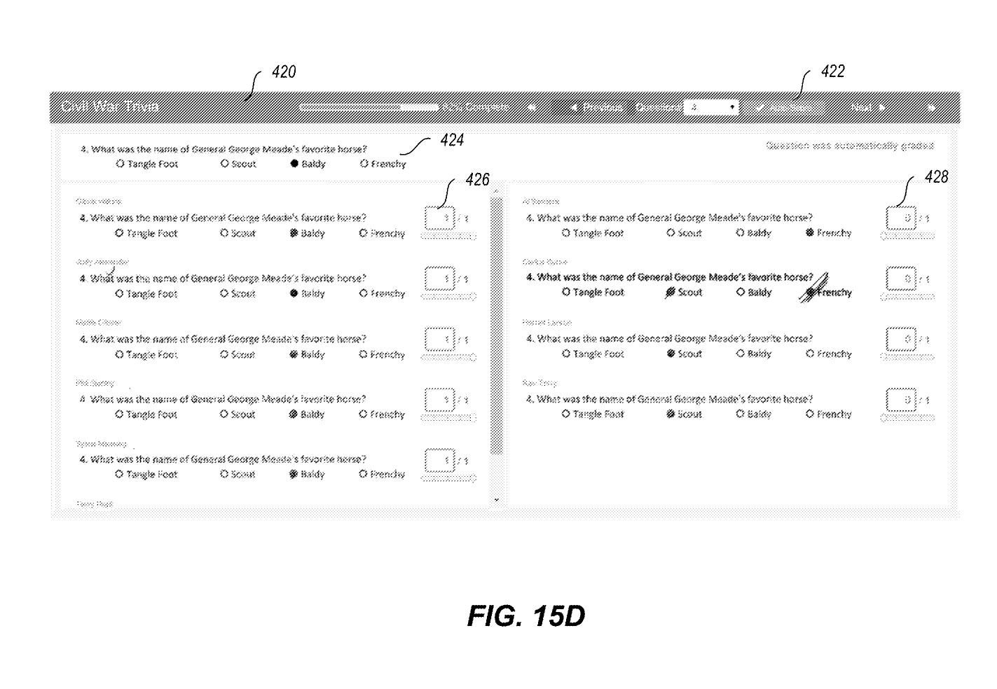

FIG. 15A shows one implementation of an example screenshot of a computer screen 290 of a computer-based grading system running in the Microsoft Windows™ environment used by a teacher to grade an examination.

After digital images of the students completed tests have been captured, processed and associated with the assignment and students, the teacher starts a grading application for the assignment. A test may have two types of questions: those questions that can be graded via a computer without teacher review and those that require teacher evaluation of each question and the answer. For those questions that can be auto-graded by the computer, these are automatically graded by the system when the images are submitted to the system. There will be some questions in which the teacher needs to visually review and grade the answers. In those cases, as with traditional paper grading, the teacher may grade page-by-page, grading all answers by student 1, then all answers by student 2 and so on. However it will usually be much faster to grade question-by-question, which is essentially impossible to do with ordinary paper grading.

In FIG. 15A, the answer key 292 for one particular question is displayed at the top of the screen 290 and is taken from the answer key 102 that was analyzed by the computer-assisted grading system 106 to identify each question and its associated correct answer. In one or more implementations, this answer key may be taken from the answer database 108. In this example, question number 1 is a short answer question asking how long a U.S. senator term is in years.

In this example, all student responses for question number 1 are extracted from digital images of each of the completed tests 266 and are placed in a column 294 shown below answer key 292. At this point, after all of the individual answers are displayed on the screen 290, the teacher can quickly scan down the response column 294 to find incorrect answers. In this example, the teacher moves an incorrect answer 298 to a right column 300. The teacher may do this, for example, by double-clicking a student response, or by using a mouse or a touchscreen selecting and dragging the incorrect answer to the right column 300. In this way, all responses to one test question can be graded at once.

As will be appreciated, the same question might not be question 1 in all tests. Using the test of FIG. 4B as an example, the very same 11 questions can be in a different order on each test. Question 1 can be listed as question 6 on one test and as question 10 on another. Thus, a student looking at another student's test cannot look at the same question and cheat to get the answer. Yet, when the inventive system sorts the questions for grading by the teacher, the same question, regardless of its number on the test, will be presented to the teacher for grading. The questions can be graded and scores reported on a per-question basis via a quickly generated computer report. Namely, the person scoring the test, whether teacher or assistant, will have presented to them, the same question from all exams. They can then quickly mark and grade that single question for all exams. They can then go to the next question and have that single question presented from all exams. This can be done regardless of whether the question was numbered 1, 6 or 10 on the exam. Then, the score can be saved and analyzed on a per-question basis for all tests. With current standard paper tests, this is not possible, or if done, is very time consuming to achieve.

FIG. 15B shows one implementation of an example screenshot of a computer screen 302 of a computer-based grading system running in the Microsoft Windows™ environment. This implementation shows certain kinds of questions that can be automatically graded. For example, when grading an auto-gradable question, an Auto Grade function selection 304 is enabled, allowing the entire set of responses to be graded in one click of the Auto Grade function selection 304.

Multiple choice questions are obviously auto-gradable but other types of questions can be too. Isolated single letters and digits can be recognized fairly accurately, which training can improve over time. So, for example, a set of questions selected from a shared set of lettered or numbered answers could be auto-graded.

Similarly, handwriting recognition can expand the range of questions amenable to auto-grading. For example, if the question set and answer menu pattern is used, the hand written single letter answer labels can be recognized with high reliability.

Other benefits of computerized grading compared to hand grading is the ability to enter more lengthy notes in the margins of individual student responses 298, 310, as they can be typed rather than handwritten into the margins.

Finally, results from the test grades may be automatically recorded in a gradebook or the grade database 110 and are immediately available. Rather than waiting days for their scores, by which time it is often too late to do anything about their errors; students can see right away what they missed for extra study and perhaps even offer an opportunity to improve.

While top-level grades are going into the grade book, the system also can track student responses to every question which, in some implementations, may be stored in the grade database 110. This data enables much more advanced and nuanced analytics. For example, teachers will be able to determine which sets of students are struggling with particular concepts. Analytics can be used to generate follow-up homework and tests and to help detect cheating.

Also, anti-cheating techniques become more feasible. For example, several versions of a test can be created that vary the order of questions and answers. The system will then select for grading that same question across all test variants. The same question, whether it appeared as question 2, 6, 17 or 27 in the test the student took, will be organized and presented together on a single screen to the teacher. The teacher will therefore be grading the very same question at the same time across all test variants.

FIG. 15C shows another implementation of an example screenshot of a computer screen 400 of a computer-based grading system running in the Microsoft Windows™ environment where question number 3 of completed tests on Civil War trivia are being graded by the teacher. Using the interface on computer screen 400, the teacher can select a previous question to grade 402, determine the current question number being graded 404 or go to the next question to be graded 408. The auto score function 406 can be selected to auto score these test questions. Here, it is turned off. The correct answer, from the test key 102, is displayed to the teacher 410. The teacher then reviews each answer, giving a correct answer appoint value of 1, reference number 412 added or for an incorrect answer of 0, reference number 414. In one or more implementations, a correct or incorrect answer may be graded at different numeric values, and a partially correct answer falling between a correct and incorrect answer may be graded between a correct and incorrect answer. In one example, a teacher may use a slider bar 412a, 414a to indicate the grade.

FIG. 15D shows one implementation of an example screenshot of a computer screen 320 of a computer-based grading system running in the Microsoft Windows™ environment.

An Auto-Score feature can be used after the teacher has manually separated the questions between right (on the left) and wrong (on the right). The command gives responses on the left no credit and responses on the right full credit. This is different form the Auto-Grade feature that scores the responses without the teacher having to do anything.

Using the interface on computer screen 420, the teacher can select the auto score function 422, which is currently selected, and the system will automatically score the questions against answer for the current question 424. Answers that are correct are graded with a 1 426, and those that are incorrect are graded with a 0 428.

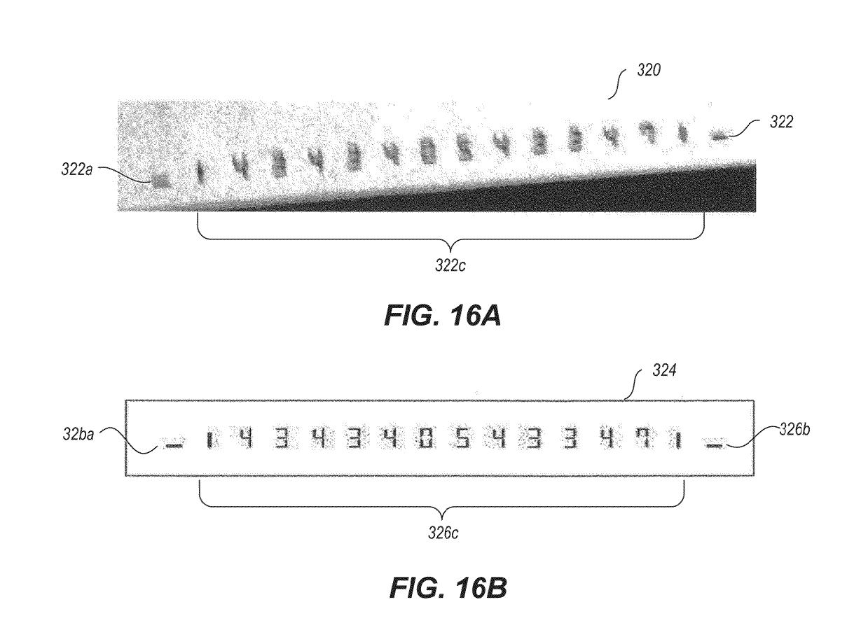

FIG. 16A shows an example of blur and smear caused by improper focus and camera motion in a digital image of part of a test page 320. A common error in digital images is blur and smear caused by improper focus and camera motion. This source test page digital image 320 shows how even a slight motion of the hand can make the page code rather hard to automatically recognize.

Obviously it is best to avoid such errors in the first place by, for example, using a camera stand 264 or platform, but these errors cannot be entirely be avoided so it is desirable to be able to fix them in the digital image. When an ideal image is known, image processing techniques like Wiener de-convolution can be applied to automatically correct these errors. For this purpose, a pair of short orthogonal bars are added left 322a and right 322b of the code 322c as shown in the source test page digital image 320. A Wiener filter determines the best de-convolution pattern to undo the error. The same filter can then be applied to improve the code digits 322c for recognition purposes.

FIG. 16B shows the result of an image processing technique like Wiener de-convolution, resulting in code 326c located between the left 326a and right 326b orthogonal bars. At this point, the code 326c is used to identify the source image so that character-by-character locations on the test page are known, and the same de-convolution technique can be used throughout the page, for example to determine student answers.

FIG. 17A-17D show an implementation of an algorithm that uses fiducial marks to align images. The fiducial marks added to the page when it was submitted previously can be easily used to adjust scanned images. The principal sources of error are feeder or by-hand placement, misalignment, and wrong orientation when pages are fed in upside-down. Differences in scale must also be corrected as scans may be made at many different resolutions. These transformations are very easily inverted once the fiducial marks are located in an image.

FIG. 17A shows diagram 1100 which graphically describes one implementation of a camera 330 after gaze and azimuth transformations have occurred.

In summary, the transformation is modeled as a translation followed by a rotation followed by a rescaling. That is, if the X is a point on the page, the target point on the scanned image would be calculated as in FIG. 17A.

X′=S·R·(X+T)

The translation T contributes two parameters, the rotation R adds one parameter and, supposing the scale is the same in both directions, S adds another parameter, for a total of four parameters. Therefore, given just two pairs of corresponding points, say two opposite fiducial marks (see FIG. 12A, items 274a-274d), the transform can be reversed. Error should be small because of the high quality of scanned images, but can be further reduced if all four corner fiducial marks are used.

The fiducial marks are even more important for images taken by camera which adds a projection transformation. The camera transformation converts points in the source plane of the paper to points in the target plane of the camera image. It is convenient to divide the camera transform into five simpler composed transforms as in this figure.

X′=S·R(γ)·P(β,c)·R(α)·(X+G)

The components of the transform are as follows.
Center of gaze (the point of source plane that is in the center of the camera's view) translation by G adding two parameters.
Camera azimuth (the angle of the camera in the source plane) rotation R(α) adding one parameter.
Camera projection P(β,c) into the plane orthogonal and passing through the center of gaze. This adds two parameters, the camera declination angle β from the vertical and the distance c of the camera from the center of gaze.
Camera tilt (angle of the camera is held relative to the vertical) rotation R(γ) adding one parameter.
Camera scale S converting distance in the rotated projective plane to pixels in the image. Usually cameras will scale the same horizontally and vertically adding one parameter.

The transform then has seven parameters but there are eight correspondences available (four fiducial marks with two coordinates each) so the transform can be inferred and then inverted.

The projection P(β,c) is unusual and is worth considering in detail. As shown in FIG. 17A, after the center of gaze and camera azimuth transforms, the camera can be considered as looking from a distance c at the origin of an XY plane along the Y axis, but at a declination angle β from the Z axis as shown in FIG. 17A. In the XYZ coordinates, the camera's location is (0,c·sin(β),c·cos(β)).

FIG. 17B shows diagram 1150 which graphically describes one implementation of the camera projection onto an orthogonal plane.

The projection transformation is onto the plane passing through the origin and perpendicular to the camera's direction of gaze as shown on the left. Impose a coordinate system UV on the projection plane as the rotation of the XY by the angle β around the X axis as shown in FIG. 17B.

FIG. 17C shows diagram 1200 which graphically describes one implementation of the source and target point the camera transform that are collinear with the camera.

As shown next, the projection takes point S in the XY plane to point T in the UV plane which is collinear with S and the camera. Let the 3D coordinates of S be (x,y,0) and the UV coordinates of T be (u,v). We want to determine the values of u and v given x and y.

FIG. 17D shows diagram 1250 which graphically describes one implementation of rotation of the transform target into the XY plane.

To do that, rotate the camera location S and T by −β around the X axis as shown left. The camera location is rotated to (0,0,c), point S is rotated to (x, y·cos(β), y·sin(β)) and T is rotated to the 3D location (u,v,0). The rotation is rigid so the three points are still collinear as shown here.

Use a parameter t to define the line through the camera and S.

L=(0,0,c)+t·[(x,y·cos(β), y·sin(β))−(0,0,c)]=(t·x,t·[y·cos(β)], c+t·[y·sin(β)−c])

Let t_{T} be the value of the parameter t when the lines passes through the target point T.

(u,v,0)=(t_{T}·x,t_{T}·[y·cos(β)],c+t_{T}·[y·sin(β)−c])

Determine t_{T} by solving the equation for the zero Z coordinate.

0=c+t_{T}·(y·sin(β)−c)

t_{T}=c/(c−y·sin)β))

Now compute u and v.

u=t_{T}·x=x·c/(c−y·sin)β))

v=t_{T}·(y·cos(β))=y·c·cos(β)/(c−y·sin(β))

The camera projection transform inverse is easily shown to be

y=v·c/(c·cos(β)+v·sin(β))

x=u·c·cos(β)/(c·cos(β)+v·sin(β))

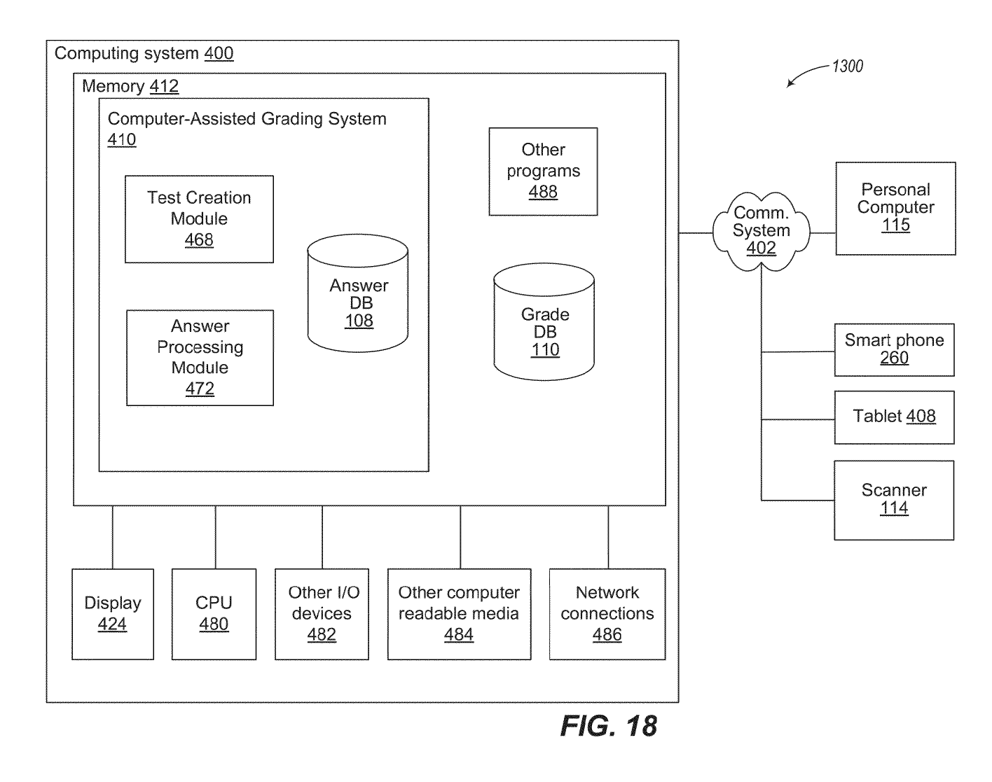

FIG. 18 shows diagram 1300 of one implementation of a computing system for implementing a Computer-Assisted Grading System 410. FIG. 18 includes a computing system 400 that may be utilized to implement Computer-Assisted Grading System 410 with features and functions as described above. One or more general-purpose or special-purpose computing systems may be used to implement the Computer-Assisted Grading System 410. More specifically, the computing system 400 may include one or more distinct computing systems present having distributed locations, such as within a set-top box, or within a personal computing device. In addition, each block shown may represent one or more such blocks as appropriate to a specific embodiment or may be combined with other blocks. Moreover, the various blocks of the Computer-Assisted Grading System 410 may physically reside on one or more machines, which may use standard inter-process communication mechanisms (e.g., TCP/IP) to communicate with each other. Further, the Computer-Assisted Grading System 410 may be implemented in software, hardware, firmware or some combination to achieve the capabilities described herein.

In the embodiment shown, computing system 400 includes a computer memory 412, a display 424, one or more Central Processing Units (“CPUs”) 480, input/output devices 482 (e.g., keyboard, mouse, joystick, track pad, LCD display, smartphone display, tablet and the like), other computer-readable media 484 and network connections 486 (e.g., Internet network connections or connections to audiovisual content distributors). In other embodiments, some portion of the contents of some or all of the components of the Computer-Assisted Grading System 410 may be stored on and/or transmitted over other computer-readable media 484 or over network connections 486. The components of the Computer-Assisted Grading System 410 preferably execute on one or more CPUs 480 to facilitate the creation of test keys 102, create distributable tests 116a-116c, and receive and process digital images of the completed tests to facilitate test grading and the recording of the test grades. Other code or programs 388 (e.g., a Web server, a database management system, and the like), and potentially one or more other data repositories 320, also reside in the computer memory 312, and preferably execute on one or more CPUs 380. Not all of the components in FIG. 18 are required for each implementation. For example, some embodiments embedded in other software do not provide means for user input or display for a customer computing system.

In a typical embodiment, the Computer-Assisted Grading System 410 includes a test creation module 468 and an answer processing module 472. The test creation module 468 implements at least the functionality described in FIGS. 1 to 10 to assist teacher 100 in creating a test answer key 102 that is then used to create individual tests 116a-116c to be handed out to students 104a-104c. The test creation module 468, in one or more implementations, receives questions, answer choices, methods for students to indicate answers on a test, and an indication of the correct answer from a teacher 100 on a test key 102. In one or more embodiments, the test key may be an electronic document that is created and stored using the computer-assisted grading system 106.

In addition, the test creation module 468 may receive identification information for a particular test or a page of a particular test, identification information for the course associated with the test, or identification information for a particular student who should receive a particular test. The test creation module 468, in various combinations of human and computer-based interaction, identifies each question on the test page, its associated answer choices, and an indication of the correct answer for the question, and stores that in an answer database 108. This may be implemented in a variety of methods, including the methods described in FIGS. 5A-5B. In addition, this information is then used, after removing the indication of the correct answer for the question, to create the question and answer choices portion of the distributable test 116a-116c. The test creation module 468 also adds fiducial marks on the printed test pages to allow for the inputting of completed tests.

The answer processing module 472 implements at least the functionality described in FIGS. 11A-17D to assist the teacher 100 in grading the completed tests. The answer processing module 472, in one or more implementations, receives digital images of completed tests, typically through a scanner 114 or through digital image photography using, for example, the camera in a smartphone 260. It then aligns the receives digital image using the fiducial marks on the completed test, identifies the test, the course, and/or the individual student using identification information printed on the test, and extracts the individual test questions and their associated answers from the aligned digital images of each of the completed tests.

During the grading process, in one implementation, for each question on the test, an identification of the question and its correct answer, which may be retrieved from the answer database 108, is presented to the evaluator 100, along with the corresponding question and answers for each of the completed tests submitted by students 104a-104c. The presentation of this information to the teacher 100 may be done through a personal computer 115, smartphone 260, tablet 408, or the like, which may be connected through Communications Systems 402. This allows the evaluator 100 to efficiently grade all answers to a particular question of a test at the same time and to select which answers are correct and incorrect. In some implementations, the answer processing module 472 uses computer vision and pattern recognition to identify correct and incorrect answers.

Information on those questions answered correctly and incorrectly, in addition to the associated grade, is stored for each student in grade database 110.

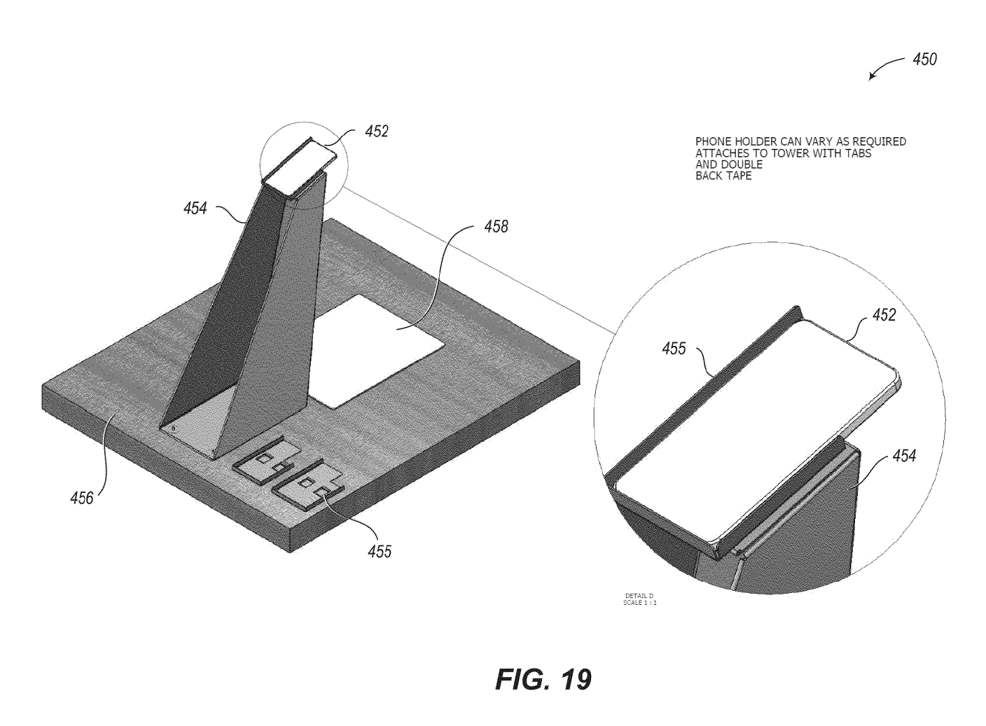

FIG. 19 shows an example 3-D drawing of one implementation of a smartphone attached to a stand 454 that is coupled to a platform 456 that is photographing a completed test paper 458. There are smartphone holders 455 that are provided for use with the stand 454. In particular, the smartphone 452 will be connected to the stand 454 with a holder 455 that is custom shaped. It is known that the footprint of an Apple iPhone® is different than the footprint of a Samsung or a Nokia smartphone. Accordingly, an acceptable holder 455 is made for the different models of smartphones 452. The teacher, getting ready to photograph the test, selects the holder 455 which is a match for his phone, depending on the brand and style of his phone. The instructor then connects the phone holder 455 to the tower with the appropriate tabs and fasteners. This permits the smartphone 452 to rest easily in the holder 455 as shown in FIG. 19 and have the camera exposed for easily taking the picture.

Each time a new phone comes on the market, a custom phone holder 455 can be provided which will match for holding the smartphone 452 and can be rigidly attached to the stand 454 to support it in the proper position.

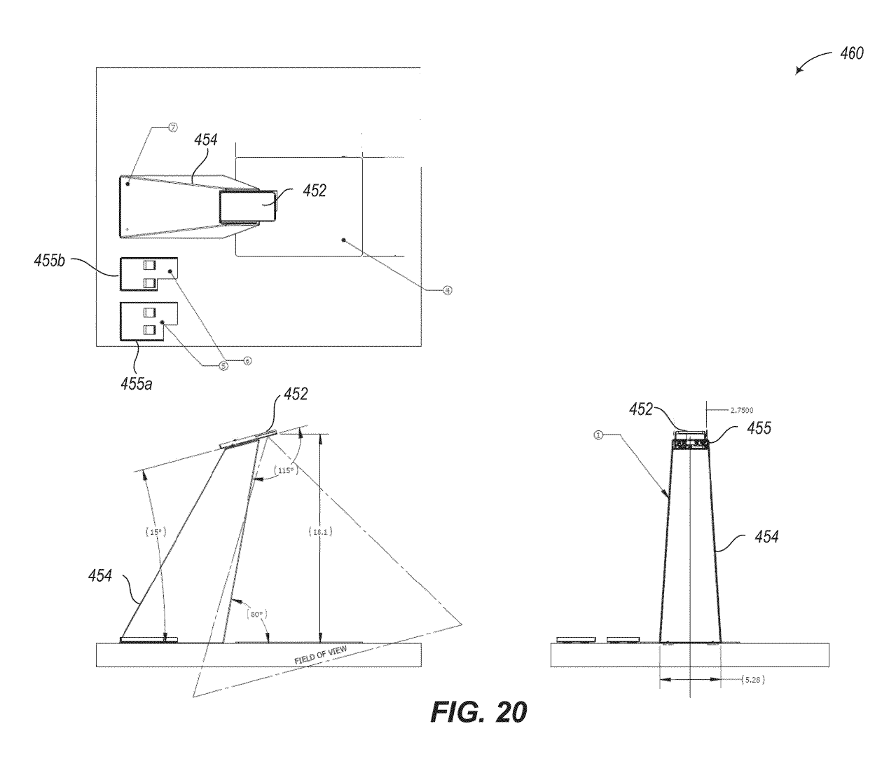

FIG. 20 shows a plan view 460 of the smartphone camera stand described in FIG. 19. In particular, FIG. 20 shows two different shapes of folders, 455a and 455b. In this example, 455a is for a Nokia Windows Phone and 455b is shown for an Apple iPhone 6®, small version. The camera has a field of view which has been custom selected to be able to capture any acceptable size of test paper 458. Further, the angle has been selected so that there will not be distortion over the entire length of the test paper 458 from the top to the bottom. As shown in FIG. 20, an angle of 80 degrees is acceptable and a height of approximately 18 inches. The teacher can take pictures of each test 458 and very quickly have all tests from the class digitized and photographs in the phone 452 which can then be transferred to a computer for quickly grading, as described herein.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for computer assistance in scoring paper tests, comprising:
inputting test questions and corresponding test answers into a computer system;
storing the inputted test questions and corresponding test answers into a memory of the computer system;
formatting the test questions into a document that contains fiducial markers on the same page as the test questions;
printing out the test questions on a sheet of paper that includes the fiducial markers and the test questions on the same sheet of paper;
receiving the sheet of paper having candidate answers filled out for the test questions;
creating a digital image of the sheet of paper having the candidate answers to the test questions;
inputting the digital image of the sheet of paper into a memory of the computer system; and
comparing, for each test question, the candidate answers against the stored test answers; and
storing a result of the comparison.

2. The method of claim 1 wherein comparing the candidate answer against the stored test answer further comprises presenting the answers to the test questions on a visual display of the computer system for viewing by a human test grader.

3. The method of claim 2 wherein presenting the answers to the test questions on a visual display of the computer system further comprises:
presenting, on the visual display, one test question and its corresponding test answer;
presenting, on the visual display, one or more corresponding candidate answers from one or more inputted digital images of received sheets of paper having candidate answers; and
receiving, from the test grader, an indication of the one or more corresponding candidate answers that are correct.

4. The method of claim 1 wherein comparing the candidate answer against the stored test answer is done by the computer system without human involvement.

5. The method of claim 1 wherein inputting the digital image of the sheet of paper further comprises:
identifying the location of the fiducial markers on the digital image of the sheet of paper;
determining, based on the identified location of the fiducial markers, the location of the candidate answers on the digital image of the sheet of paper; and
extracting the candidate answers.

6. The method of claim 5, further comprising:
determining, based on the identified location of the fiducial markers, whether the digital image is skewed in relation to the original sheet of paper; and
if the digital image is skewed, applying a transformation to the digital image to remove the skew.

7. The method of claim 1 wherein the digital image of the sheet of paper having the candidate answers to the test questions is created using one of a camera or a scanner.

8. The method of claim 7 wherein the camera is attached to a pedestal.

9. The method of claim 1 wherein formatting the test questions into a document that contains fiducial markers and the test questions on the same sheet of paper further includes:
receiving an identification code for each test page; and
adding the received identification code to each test page.

10. The method of claim 1 wherein formatting the test questions into a document that contains fiducial markers and the test questions on the same sheet of paper further includes:
varying the location and order of placement of the test questions on the document; and wherein inputting the digital image of the sheet of paper further includes:
determining, based on image recognition, the location of the candidate answers on the digital image of the sheet of paper; and
extracting the candidate answers.

11. A method for computer assistance in scoring paper tests, comprising:
creating a set of fiducial marks on a sheet of paper;
sending the sheet of paper for editing;
receiving a digital image of the edited sheet of paper;
identifying, using only the fiducial marks indicated on the digital image of the edited sheet of paper, the edits made to the sheet of paper; and
outputting the identified edits.

12. The method of claim 11 wherein identifying the edits made to the sheet of paper further comprises:
aligning, using only the fiducial marks indicated on the digital image of the edited sheet of paper, the received digital image of the edited sheet of paper to correspond to the corresponding sent sheet of paper;
comparing the contents of the aligned digital image of the edited sheet of paper with the contents of the sent sheet of paper; and
storing the differences as identified edits.

13. A computer-based system for scoring paper tests, comprising:
a processor;
an input device communicatively coupled to the processor;
an output device communicatively coupled to the processor;
a non-transitory computer-readable memory communicatively coupled to the processor, the memory storing computer-executable instructions that, when executed, cause the processor to:
input test questions and corresponding test answers into the computer system;
store the inputted test questions and corresponding inputted test answers into a memory of the computer system;
format the test questions into a document that contains fiducial markers on the same page as the test questions;
print out the test questions on a sheet of paper that includes the fiducial markers and the test questions on the same sheet of paper;
receive the sheet of paper having candidate answers filled out for the test questions;
create a digital image of the sheet of paper having the candidate answers to the test questions;
input the digital image of the sheet of paper into a memory of the computer system;
compare, for each test question, the candidate answers against the stored test answers; and
store the result of the comparison.

14. The system of claim 13 wherein compare the candidate answer against the stored test answer further comprises present the answers to the test questions on a visual display of the computer system for viewing by a human test grader.

15. The system of claim 14 wherein present the answers to the test questions on a visual display of the computer system further comprises:
present, on the visual display, one test question and its corresponding test answer;
present, on the visual display, one or more corresponding candidate answers from one or more inputted digital images of received sheets of paper having candidate answers; and
receive, from the test grader, an indication of the one or more corresponding candidate answers that are correct.

16. The system of claim 14 wherein compare the candidate answer against the stored test answer is done by the computer system without human involvement.

17. The system of claim 14 wherein input the digital image of the sheet of paper further comprises:
identify the location of the fiducial markers on the digital image of the sheet of paper;
determine, based on the identified location of the fiducial markers, the location of the candidate answers on the digital image of the sheet of paper; and
extract the candidate answers.

18. The system of claim 17 further comprising:
determine, based on the identified location of the fiducial markers, whether the digital image is skewed in relation to the original sheet of paper; and
if the digital image is skewed, apply a transformation to the digital image to remove the skew.

19. The system of claim 14 wherein the digital image of the sheet of paper having the candidate answers to the test questions is created using one of a camera or a scanner.

20. A non-transitory computer-readable storage medium having stored contents that configure a computing system to perform a method, the method comprising:
inputting test questions and corresponding test answers into a computer system;
storing the inputted test questions and corresponding inputted test answers into a memory of the computer system;
formatting the test questions into a document that contains fiducial markers on the same page as the test questions;
printing out the test questions on a sheet of paper that includes the fiducial markers and the test questions on the same sheet of paper;
receiving the sheet of paper having candidate answers filled out for the test questions;
creating a digital image of the sheet of paper having the candidate answers to the test questions;
inputting the digital image of the sheet of paper into a memory of the computer system;
comparing, for each test question, the candidate answers against the stored test answers; and
storing the result of the comparison.
